(19) United States
(12) Patent Application Publication
(10) Pub. No.: US 2024/0073628 A1
(43) Pub. Date: Feb. 29, 2024

(54) HEARING DEVICE

(71) Applicant: Sivantos Pte. Ltd., Singapore (SG)

(72) Inventors: Kevin Bayer, Erlangen (DE); Manuel Weiss, Erlangen (DE)

(21) Appl. No.: 18/458,349

(22) Filed: Aug. 30, 2023

(30) Foreign Application Priority Data
Aug. 30, 2022 (DE) 10 2022 209 000.4

(51) Int. Cl. H04R 25/00; H04R 25/02

(52) U.S. Cl. CPC H04R 25/40; H04R 25/02; H04R 25/65; H04R 2225/0216; H04R 2225/57

(57) ABSTRACT

A hearing device has a housing, which is formed with an opening that is acoustically connected to a microphone inside the housing. The hearing device has a lighting unit situated inside the housing, which is optically coupled to a light guide, by way of which the opening is closed. The light guide has a further opening formed inside the opening in the housing.

### CROSS-REFERENCE TO RELATED APPLICATION

This application claims the priority, under 35 U.S.C. § 119, of German Patent Application DE 10 2022 209 000.4, filed Aug. 30, 2022; the prior application is herewith incorporated by reference in its entirety.

### FIELD AND BACKGROUND OF THE INVENTION

The invention relates to a hearing device comprising a housing, which has an opening. A microphone that is disposed inside the housing is acoustically connected to the opening.

Persons who suffer from a diminished hearing ability usually employ a hearing aid, which is a hearing device. In this case, ambient sound is converted, usually by means of a microphone, i.e., an electromechanical sound transducer, into an electrical (audio/sound) signal, so that the electric signal is detected. The detected electric signals are processed by means of an amplifier circuit and introduced by means of a further electromechanical transducer in the form of an earpiece into the auditory canal of the person. Moreover, a processing of the detected sound signals usually occurs, for which a signal processor of the amplifier circuit is usually employed. The amplification in that case is attuned to the given hearing loss of the hearing device wearer. The (sound) transducer and the amplifier circuit are usually arranged in a housing and in this way they are at least partially protected against environmental influences.

In order for ambient sound to arrive undistorted at the microphone, the housing usually has an opening, to which the microphone is acoustically connected. However, it is possible for foreign particles to enter the housing through the opening and thereby cause damage to the components of the hearing device which are located there, such as the microphone. It is also possible for the foreign particles to at least partially block the opening, so that the ambient sound only penetrates to a reduced extent, resulting in a loss of comfort for the person. As a remedy for this, it is known to use seals, such as a labyrinth seal, which are arranged between an outer entrance of the opening and the microphone. This produces a relatively complex design for the housing, so that manufacturing costs are increased.

For the signaling of a status or other events, light sources such as an LED (light-emitting diode) are being used increasingly. These are likewise arranged inside the housing, which facilitates their energization. However, it is therefore necessary to provide an additional opening in the housing, so that light given off by means of the light source can be perceived from outside the housing. In order to also prevent the penetration of foreign particles, the additional opening is usually covered with a transparent plastic, which is materially joined to other components of the housing. This results in additional work steps, which increases the assembly time. A potential point of leakage is also present, so that a quality inspection must be carried out here, and the manufacturing time becomes longer and the manufacturing costs are increased.

### SUMMARY OF THE INVENTION

It is accordingly an object of the invention to provide a hearing device, which overcomes the above-mentioned disadvantages of the heretofore-known devices and methods of this general type and which provides for an especially suitable hearing device for which the comfort in particular and/or the operating safety are increased.

With the above and other objects in view there is provided, in accordance with the invention, a hearing device, comprising:
a housing formed with an opening;
a microphone disposed in the housing and acoustically connected to the opening;
a light guide disposed to close the opening;
a lighting unit disposed inside the housing and optically coupled to the light guide;
the light guide being formed with a further opening inside the opening of the housing.

By way of example, the hearing device is a headphone or it includes a headphone, and the hearing device is a headset. Especially preferably, however, the hearing device is a hearing aid device, or hearing aid, for short. The hearing aid serves to assist a person suffering from a diminished hearing ability. In other words, the hearing aid is a medical device, by means of which a partial hearing loss is compensated, for example. The hearing aid may be a “receiver-in-the-canal” hearing aid (RIC; ex-earpiece hearing aid), an “in-the-ear” hearing aid, an “in-the-canal” hearing aid (ITC) or a “complete-in-canal” hearing aid (CIC), hearing spectacles, a pocket hearing aid, a bone conduction hearing aid or an implant. Alternatively, the hearing aid is a “behind-the-ear” hearing aid (BTE), which is worn behind the outer ear.

The hearing device is configured to be worn on the human body. In other words, the hearing device preferably contains a holding device, by means of which a fastening to the human body is possible. Insofar as the hearing device is a hearing aid, the hearing device is adapted and intended to be arranged, for example, behind the ear or inside the auditory canal. In particular, the hearing device is wireless and configured to be introduced, at least partially, in the auditory canal.

The hearing device comprises a microphone, serving for acquiring sound. In particular, an ambient sound or at least a portion thereof is detected by means of the microphone during operation. The microphone is, in particular, an electromechanical sound transducer. The hearing device comprises, for example, only a single microphone or multiple microphones interacting with each other. The microphone or each microphone advisedly comprises a membrane, which is placed in vibrations by means of sound waves, and the vibrations are transformed by means of a corresponding receiver device, such as a magnet moving in a coil, into an electric signal. Alternatively, the microphone is designed as an electret/MEMS capacitor microphone. It is at least possible for the respective microphone to detect an audio signal based on the sound impinging on the microphone. The microphone or the microphones, in particular, are omnidirectional.

Advisedly, the hearing device comprises an earpiece for putting out an output signal. The output signal is an electric signal. The earpiece is, for example, an electromechanical sound transducer, preferably a loudspeaker. Depending on the design of the hearing device, in the normal state the earpiece is arranged at least partly inside the auditory canal of the wearer of the hearing device, i.e., a person, or it is at least acoustically connected to it. The hearing device serves primarily for putting out the output signal by way of the earpiece, whereupon a corresponding sound is produced. In other words, the principal function of the hearing device is preferably the putting out of the output signal. The output signal is at least partly produced in dependence on the sound acquired by way of the microphone.

The hearing device advisedly comprises a signal processor, which suitably constitutes a signal processing unit or is at least part of such a unit. However, the hearing device advisedly comprises at least one corresponding signal processing unit. The signal processor is for example a digital signal processor (DSP) or it is realized by means of analog components. By means of the signal processor, the (audio) signal produced by means of the microphone is adapted in dependence on the particular hearing loss of the wearer of the hearing device. Advisedly, an A/D (analog-to-digital) converter is arranged between the microphone and the signal processing unit, for example the signal processor, insofar as the signal processor is designed as a digital signal processor. The signal processor is adjusted in particular according to a parameter set. By means of the parameter set, the amplification in different frequency ranges is dictated, so that the signal produced by means of the microphone is processed according to certain rules, in particular in dependence on the hearing loss of the wearer of the hearing device. Especially preferably, the hearing device additionally comprises an amplifier, or the amplifier is at least partly formed by means of the signal processor. For example, the amplifier is inserted before or after the signal processor in the circuitry.

The hearing device comprises a housing. The microphone is disposed inside the housing. Insofar as the earpiece is present, this is likewise situated for example inside the housing or a further separate housing, the further housing being situated, in the normal condition, in the auditory canal of the person, and the two housings are connected to each other in particular by signal technology. Preferably, the respective signal processing unit is likewise situated inside the housing. Preferably, a power supply unit such as a battery is arranged inside the housing, by means of which the components situated therein are energized during operation. The housing forms an outer skin of the hearing device and thus the outer boundary of the hearing device. The housing is typically made of a plastic, such as a fiberglass-reinforced plastic, so that the surrounded parts of the hearing device are protected by the housing.

The housing has an opening. The microphone is acoustically connected to the opening. It is thus possible for sound from the surroundings of the hearing device, i.e., ambient sound, to arrive at the microphone via the opening, namely, through the opening. That is, no attenuation and/or other change occurs in the sound until it arrives at the microphone. Thus, in summary, the microphone is acoustically coupled to the opening. In particular, the opening reaches as far as the microphone. Suitably, the opening has an entrance on the outer side of the housing and advisedly reaches as far as the microphone, so that the opening is advisedly closed at one end by means of the microphone. However, the microphone is arranged at least such in regard to the opening that sound entering through the opening can be detected by means of the microphone and is also preferably so detected during operation.

In accordance with a further feature of the invention, the hearing device includes a lighting unit. The lighting unit comprises, for example, only a single light source, such as an LED (light-emitting diode). Especially preferably, the lighting unit comprises multiple such LEDs, the LEDs being advisedly different from each other, so that each time light having different wavelengths can be put out by means of them during the operation. For example, precisely two such LEDs are present, and the lighting unit is designed such that these are each operated separately. For example, an operating state is signaled by means of one of the LEDs and a stand-by state with the other one, the one LED in particular emitting green light and the other red light. Alternatively, a simultaneous operation of the LEDs is also possible. Preferably, the lighting unit comprises at least one further LED and is configured in particular in the manner of a color mixer. Thus, in particular, it is also to put out mixed colors by means of the lighting unit.

The lighting unit is optically coupled to a light guide, which is a light waveguide, for example, and/or which is advisedly made of plastic. Thus, the manufacturing costs and the weight are reduced. For example, the light guide is made in the form of a glass fiber at least for a portion. The light guide is suitable, and is in particular intended, to carry light given off during operation by means of the lighting unit, thus in particular electromagnetic radiation, and to deliver it to a particular site. Thus, during operation, the light emitted by means of the lighting unit is supplied at least partly, preferably completely or at least by 50%, 60% or 70%, to the light guide.

The opening is closed by means of the light guide. Thus, the light guide is arranged at least partly inside the opening, and the opening is partly covered by means of the light guide. Preferably, the light guide covers the opening. The light guide is advisedly spaced away from the entrance of the opening, and thus it is set off at least partly toward the inside from the outside of the housing. The light guide is advisedly situated between the entrance of the opening and the microphone. The light guide has a further opening, which is situated inside the opening. Thus, the size of the further opening is smaller than the size of the opening, and in particular the area of the further opening is smaller than the area of the opening. Preferably, the further opening is situated entirely inside the opening.

Thus, thanks to the further opening, sound (waves) can also continue to arrive through the opening and the further opening at the microphone, so that the sound of the surroundings, i.e., the ambient sound, can also continue to be detected by means of the microphone. Moreover, the opening serves for putting out, that is, beaming out, the light produced by means of the lighting unit and put out via the light guide in the opening to the surroundings of the housing. Consequently, only a single possible site of leakage is present in the housing, so that the operating safety is increased. The light guide holds back foreign particles at least partially, so that the operating safety is increased. Furthermore, the light guide and the further opening increase the length of the path traveled by sound through the opening, so that an acoustically altered mass is effectively present. This results in an altered frequency response, so that the comfort is increased for the user of the hearing device. Furthermore, the lighting unit and the light guide make possible an optical signaling of further information, such as particular events and/or operating states, which increases the comfort of the user. In particular, the lighting unit is appropriately actuated for this during operation and it is suitable for this, in particular, adapted and designed for this.

For example, the light guide constantly has the same roughness on its surface. Especially preferably, however, the light guide is roughened in the area of the opening, i.e., the portion of the light guide which is situated in the opening, so that an increased beaming of light from the light guide occurs here. For example, the light guide comprises multiple parts separate from each other, which are suitably joined together. Especially preferably, however, the light guide is made as a single piece, which increases its robustness. This also makes it easier to conduct the light which is coupled into it.

Preferably, the further opening is configured in dependence on a desired frequency response. In other words, the further opening is configured to produce the desired frequency response, i.e., in particular the ratio of the amplitude of the sound arriving at the microphone to the amplitude of the sound entering the opening in dependence on the frequency. Preferably, the resonance frequency is appropriately shifted. The location, the size, and/or the shape of the further opening is chosen suitably for the adapting of the desired frequency response. For example, this is done one time, in particular in dependence on the particular microphone or other components used, and/or in dependence on the wearer of the hearing device. Hence, it is possible for the light guide, namely, the further openings, to be different for different persons, in the otherwise identical hearing device. Hence, it is possible to adapt the hearing device to the particular user/person, i.e., in particular the wearer of the hearing device, simply by adapting the light guide. This requires only the replacement or reworking of a single component. Moreover, this enables a balancing of the frequency responses between multiple microphones, in particular when the hearing device contains multiple microphones. In this case, for example, only one light guide is present, and this is used to adapt the frequency response of the associated microphone to the frequency response of the other microphone. Alternatively, a corresponding light guide will be present for both microphones, so that any desired adaptation of the frequency responses to each other can occur. Thanks to the adapting of the frequency responses, it becomes easier to realize a directional microphone by means of the two microphones.

For example, only the further opening is present. Especially preferably, however, the light guide comprises multiple such further openings, which are thus likewise situated inside the opening. For example, the further openings are identical to or different from each other in their construction. For example, each further opening is round in configuration or one of the further openings, preferably several or all of them, is in the shape of a circular arc or a half moon. In particular, the light guide comprises a total of exactly 2, 3 or 4 such further openings. Thus, the mechanical integrity of the light guide is not excessively reduced, wherein it is still possible for sound waves to reach the microphone from the surroundings. Thanks to the plurality of further openings, however, it is possible to have a relatively small area for each of the further openings, so that the penetration of foreign particles can be relatively efficiently prevented.

In one modification, the light guide has a lattice-shaped segment by means of which the further openings are provided. In other words, the light guide is fashioned in the manner of a lattice in the segment and therefore it has a plurality of such further openings, although the area of each is relatively small. In this way, the arrival of the sound waves is basically unaffected, but the penetration of foreign particles is basically precluded. Also on account of the lattice-shaped segment there is a substantially homogeneous shining of the light, at least for the human eye, so that the further openings are not visible to persons, in particular. In this way, the optical impression is improved.

In one alternative or in combination with this, a further lattice is present, by means of which the opening is covered, in particular, on the inside, this further lattice being located between the microphone and the light guide, for example. By means of the further lattice, in particular, the penetrating of foreign particles to the microphone is prevented, so that the operating safety is increased. The further lattice in this case is made of metal or plastic, for example.

In accordance with a further feature, the light guide is produced integrally as a single piece with the housing. Especially preferably, however, the light guide is initially a separate component which is attached to the housing. Thus, it is possible to use different materials for the light guide and the housing, so that material costs can be reduced. It is also possible in this way, for example, to adapt the light guide to the particular needs of the wearer of the hearing device, such as the desired frequency response, while always using the same housing, or vice versa. For example, the light guide is clipped, latched, and/or press-fitted onto the housing. Especially preferably, the light guide is glued onto the housing, so that it is attached in a captive manner to the housing. No additional fastening means are required in this case, so that a relatively small-sized light guide can also be used, and no additional design space needs to be kept available. Thus, on the whole a relatively small-sized hearing device can be designed. Therefore, the aesthetic impression is further improved.

In accordance with a particularly preferred embodiment, the light guide and the housing are provided with a common coating. By means of the coating, in particular, a corrosion protection or the like is provided. Since the coating has been applied only after the fastening, in particular the gluing, the fastening of the light guide to the housing is not impeded by the coating, so that the assembly process is easier. Moreover, the fastening site, preferably the glue site, is likewise provided with the coating. Consequently, the coating provides a stabilization of this site and therefore also of the position of the light guide with respect to the housing, thereby increasing the robustness. Consequently, slight movements of the light guide relative to the housing are also avoided, which might result for example in undesirable noises, which would be picked up in particular by means of the microphone, resulting in less comfort.

In accordance with another feature, the light guide is planar in configuration. In this way, the design and production are facilitated. Especially preferably, however, the light guide has an outwardly open blind hole situated inside the opening. The blind hole is thus configured in particular in the manner of an indentation and does not run through the entire light guide. By means of the blind hole, therefore, foreign particles getting in through the entrance to the opening are held back or can at least build up there, so that they do not advance through the further opening to reach the microphone. In particular on account of capillary forces or other surface forces, the incoming foreign particles such as particles of dirt and/or moisture are taken into the blind hole, and the blind hole is configured appropriately, in particular. Preferably, therefore, the blind hole constitutes a reservoir for incoming foreign particles. In summary, thanks to the blind hole incoming foreign particles are held back from the further opening and thus from getting as far as the microphone, so that the operating safety is further increased.

In accordance with yet another feature, the opening and/or the further opening is curved in its course. This increases the length of the opening/further opening, and more foreign particles are trapped. Especially preferably, however, the opening and/or the further opening is straight in its course. The manufacturing is simplified in this case. For example, the cross section of the opening is constant over its course. Especially preferably, however, the opening is widened toward the inner end. In other words, the cross section of the opening increases at least for a portion with increasing distance from the entrance at the outer side of the housing, so that the opening has the shape of a funnel, for example, in part. Thanks to the widening and the therefore reduced capillary forces, incoming moisture is held back and prevented from reaching as far as the microphone. Alternatively or especially preferably in combination with this, the further opening is widened at the inner end, i.e., the side facing the microphone. Once again reduced capillary forces occur here in the area of the widening, so that moisture if it should get as far as the further opening and in part through this opening will be held back here. Consequently, the operating safety is increased.

In accordance with yet a further feature, the light guide is substantially planar and/or plate-shaped in the region of the opening. In other words, the light guide here is in the shape of a platelet, for example, and the one or more further openings are made in the base body provided in this way, having for example a constant cross section or a variable cross section. Preferably, the base body is situated substantially perpendicular to the course of the opening. In one modification, the light guide comprises a hollow cylindrical appendage, by means of which the opening is lined, and which is advisedly fastened to the base body, being preferably molded on it. The hollow cylindrical appendage in this case advisedly reaches as far as the edge of the housing, and the outer surface of the housing is advisedly flush with the end of the appendage. In this way, the optics and/or haptics is improved, and a depositing of dirt particles here is prevented. In particular, the appendage lies mechanically directly against the edge of the opening. For example, the appendage is fastened to the edge of the opening or especially preferably it is merely inserted there. In this way, the manufacturing is simplified.

In accordance with a concomitant feature, the appendage is in the shape of a ring, and the cross section of the opening is round. Alternatively, the cross section is rectangular, for example, or it has any desired shape, the appendage in particular mimicking the shape of the cross section of the opening. For example, the hollow cylindrical appendage has a tapering at the outwardly oriented end, so that the appendage here is substantially conical or funnel shaped and thus has an increased wall thickness. In this way, any infiltrating moisture is held back by virtue of the reduced capillary forces, so that the operating safety is increased. Also in this way a relatively large surface is created for the beaming out of the light, which increases the comfort.

Other features which are considered as characteristic for the invention are set forth in the appended claims.

Although the invention is illustrated and described herein as embodied in a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic view of a hearing device comprising multiple microphones in a housing;

FIG. 2 is a cross sectional representation, schematically simplified, of one of the microphones which is acoustically connected to an opening of the housing, which is closed by means of a light guide;

FIGS. 3-7 are top plan views of portions of various embodiments of the light guide;

FIG. 8 is a cross section, similar to FIG. 2, of an alternative embodiment of the light guide;

FIG. 9 is a cross section, similar to FIG. 2, of another alternative embodiment of the light guide;

FIG. 10 is a schematically simplified illustration of a path of sound waves through the opening;

FIG. 11 is an illustration, similar to FIG. 10, of the path of sound waves through the opening in the absence of the light guide; and

FIG. 12 is a schematically simplified chart of a frequency response.

Elements that correspond to one another are identified with the same reference signs throughout the figures.

### DETAILED DESCRIPTION OF THE INVENTION

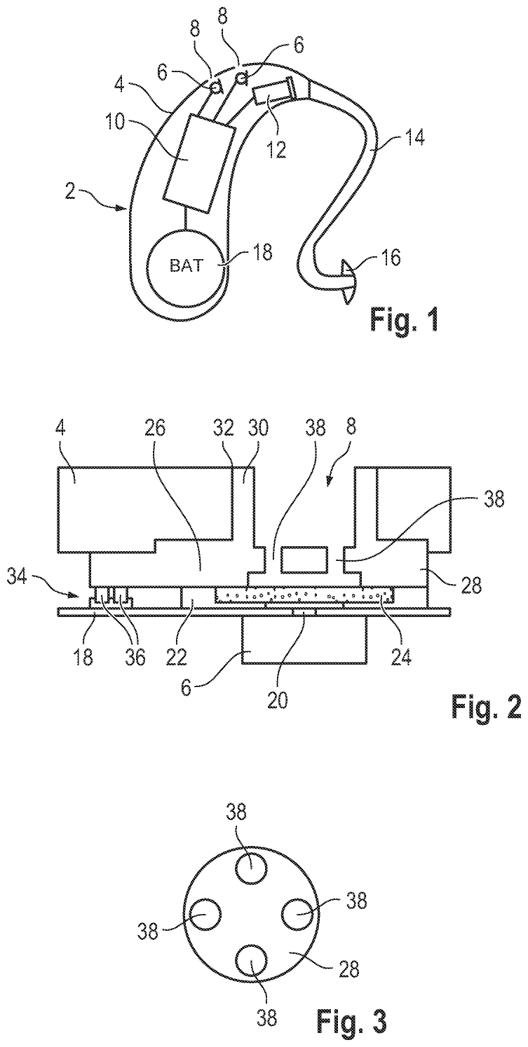

Referring now to the figures of the drawing in detail and first, in particular, to FIG. 1 thereof, there is shown a schematic illustration of a hearing device 2 in the form of a hearing aid, which is adapted and designed to be worn behind the ear of the wearer (hearing device wearer or user). In other words, this is a “behind-the-ear” hearing aid (BTE). The hearing device 2 comprises a housing 4, which is made from a plastic. Inside the housing 4 are arranged two microphones 6 each in the form of an electromechanical sound transducer, being omnidirectional in design. By changing the time offset between the acoustical signals detected by the omnidirectional microphones 6, it is possible to change the directional characteristic, so that a directional microphone is realized.

The two microphones 6 are connected via respective openings 8 of the housing 4 to the surroundings of the hearing device 2, so that sound waves and consequently sound can penetrate through the openings 8 in the housing 4 and reach the microphones 6. The microphones 6 are coupled for communication with a signal processing unit 10, which contains an amplifier circuit and a signal processor. The signal processing unit 10 is moreover formed by circuit elements, such as electrical and/or electronic components, for example. The signal processor is a digital signal processor (DSP) and it is connected for communication with the microphones 6 through an A/D (analog-to-digital) converter.

The signal processing unit 10 is coupled by signal technology to a receiver 12. By means of the receiver 12, or speaker 12, which is an electromechanical sound transducer, an (electric) signal provided by the signal processing unit 10 during operation is transformed into an output sound, i.e., into sound waves. These are conducted into an acoustic tube 14, one end of which is fastened to the housing 4. The other end of the acoustic tube 14 is surrounded by means of a dome 16, which in the normal state of use is arranged in an auditory canal of the wearer of the hearing device 2. The signal processing unit 10 is energized by means of a battery 18 arranged in the housing 4. A portion of the electrical energy is conducted from the signal processing unit 10 to the microphones 6 and to the receiver 12.

FIG. 2 shows schematically a portion of the cross sectional representation of one of the microphones 6, which is acoustically coupled to the associated opening 8 of the housing 4. The opening 8 has a circular round cross section perpendicular to the cross sectioning line. The microphone 6 is mounted on a circuit board 18, having a hole 20. It is located in the circuit boards 18 between the housing 4 and the microphone 6 and thus also between the microphone 6 and the opening 8. The hole 20 is covered by the opening 8 and reaches as far as a sound pickup opening of the microphone 6.

A seal 22 is fastened on the circuit board 18 on the side facing the housing 4, is configured as an O-ring having a larger diameter than the opening 8. A further lattice 24 is held by means of the seal 22. By means of the further lattice 24, foreign particles are prevented from going through the opening 8 to reach the hole 20 and thus the microphone 6. Furthermore, a light guide 26 is fastened to the circuit board 18 via the seal 22. The light guide 26 has a plate-shaped base body 28 situated parallel to the circuit board 18 and to the housing 4. By means of the base body 28, the opening 8 is entirely covered, so that the opening 8 is closed by means of the light guide 26.

On the base body 28, which is fastened to the housing 4 on its inner side, there is formed a hollow cylindrical appendage 30, making a single piece with it. By means of the appendage 30, the opening 8 is lined at its edge, and the end of the appendage 30 is flush with an entrance 32 of the opening 8, i.e., the end of the opening 8 facing away from the microphone 6. The light guide 26 is made from a plastic, and the end of the appendage 30 which is flush with the outside of the housing 4 is roughened. The portion of the base body 28 located inside the opening 8 is also roughened.

The light guide 26 is optically coupled to a lighting unit 34, which lies mechanically directly against the light guide 26, and which is likewise situated inside the housing 4. The lighting unit 34 is fastened to the circuit board 18 and comprises two LEDs 36 (light-emitting diodes), which are arranged such that, when they are energized, they beam for the most part into the light guide 26. Thus, during the operation of each of the LEDs 36, the light that is output in this way is delivered at least in part from the light guide 26 to the region of the opening 8, so that the light is beamed out through the opening 8. In the illustrated example, the LEDs are configured such that a red light is emitted by one of them and a green light is emitted by the other.

The light guide 26 furthermore has a total of four further openings 38, only two of them being shown in the cross sectional drawing. The further openings have a circular round cross section and they are formed entirely inside the opening 8. Thus, it is possible for sound waves entering the opening 8 to reach as far as the microphone 6 despite the light waveguide 26. The sound waves enter through the entrances 32 in the opening 8 and pass through one or more of the further openings 38. After this, the sound passes through the further lattice 24 and the hole 20, until it arrives at the microphone 6. Due to the light guide 26 and the smaller further openings 38, the undesirable penetration of foreign particles as far as the further lattice 24 or also the microphone 6 is at least partly prevented. It is also possible to put out light from the respective opening 8, so that additional information can be provided to the user of the hearing device 2.

For the assembly process, at first the light guide 26 is glued to the cell housing 4, and then both of them are provided with a coating, not otherwise shown. Thus, the glue spots are protected at least partially by means of the coating, so that even when operating in a corrosive environment the light guide 26 is prevented from detaching from the housing 4. Preferably, the coating is water repellent for this purpose. The optics of the hearing device 2 are also improved thanks to the common coating.

FIG. 3 shows in a top view that portion of the base body 28 which is located inside the opening 8. In other words, the base body 28 is shown looking into the opening 8 from the outside. The four further openings 38 are identical in configuration and arranged with rotational symmetry relative to each other.

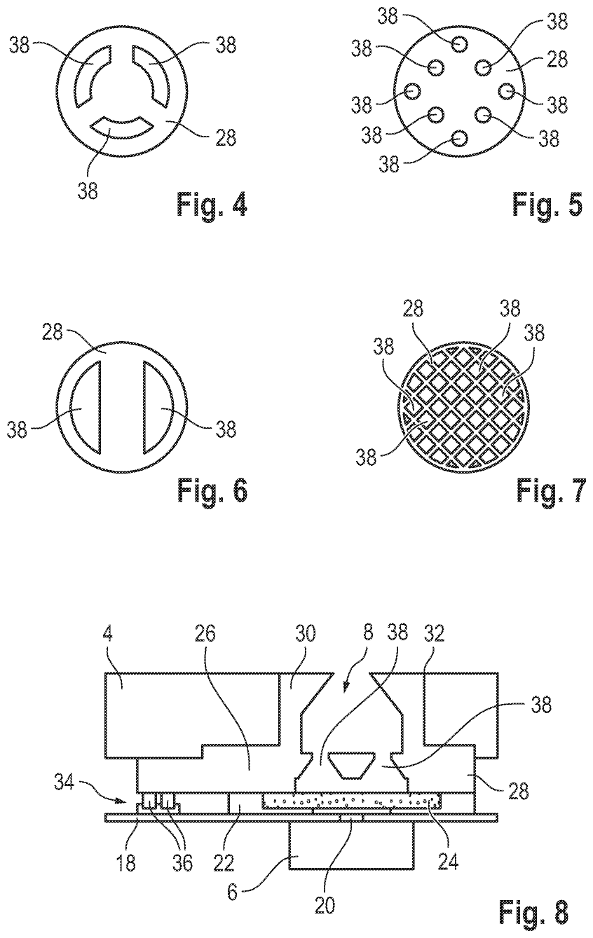

FIG. 4 shows a modification of the light guide 26, namely, the base body 28 according to the variant represented in FIG. 3. In this variant, there are a total of three further openings 38, each of them being curved. In other words, the cross section of each further opening 38 is curved perpendicular to the course of the opening 8. The further openings 38 are identical in configuration and arranged with rotational symmetry relative to the midpoint of the opening 8 or to the axis of the cylinder forming the opening 8.

FIG. 5 shows a further modification of the base body 28 corresponding to the previous representations. There are a total of eight further openings 38, the cross section of each of them being round. The further openings 38 are also arranged in a square shape.

FIG. 6 shows a further alternative. Only two further openings 38 are present, each having a half moon shape. The portion of the base body 28 shown is also axially symmetrical.

In one modification, the segment of the base body 28 located inside the opening 8 is formed by means of a lattice, which is shown in FIG. 7. In other words, the light guide 26 comprises the lattice-shaped segment by means of which the further openings 38 are provided. Consequently, there are a plurality of such further openings 38 inside the opening 8.

FIG. 8 shows a modification of the hearing device 2, similar to the representation of FIG. 2. None of the parts have been altered, except for the light guide 26. In other words, the housing 4 with the opening 8, the lighting unit 34 with the LEDs 36, the circuit board 18, the seal 22, the further lattice 24 and the microphone 6 are the same. Also, the light guide 26 continues to have the base body 28 as well as the appendage 30, by means of which the opening 8 is lined. However, the further openings 38 are now widened inwardly, so that they are funnel shaped. Due to this arrangement, moisture entering through the opening 8 and reaching to the further openings 38 is held back by virtue of the capillary effect on the base body 38, so that it does not advance to the microphone 6. Also the appendage 30 is thicker in configuration in the area of the entrance 32 and it therefore has an increased thickness. The thickness decreases with increasing proximity to the microphone 6 along a portion of the length of the appendage 30. Hence, a widening also exists here, so that moisture is already held back here by virtue of the capillary forces.

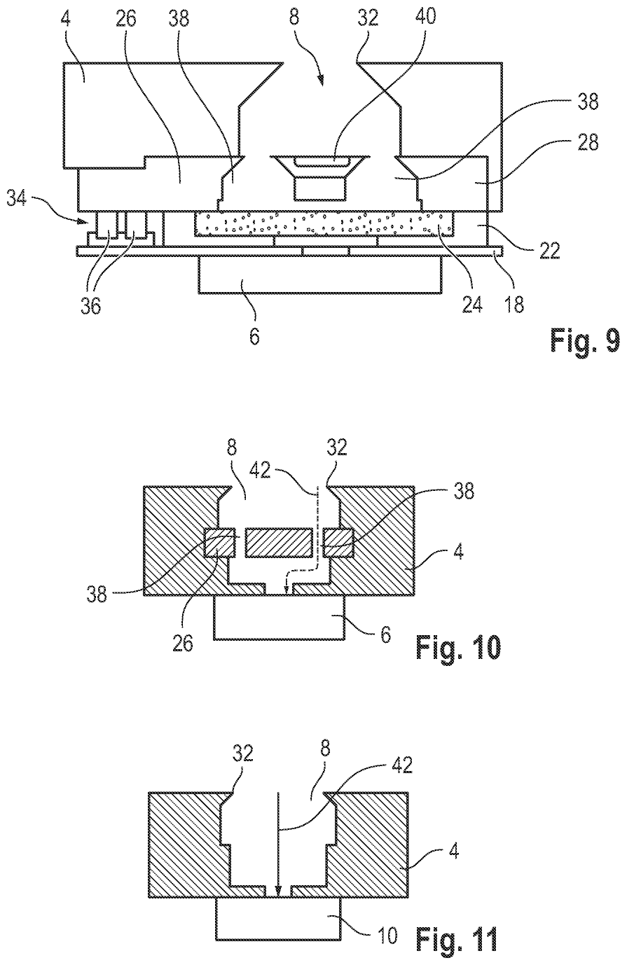

FIG. 9 shows a further modification, in which the microphone 6, the circuit board 18, the seal 22, the further lattice 24 and the lighting unit 34 with the two LEDs 36 have not been altered. But now the appendage 30 is no longer present. Hence, the opening 8 is no longer lined by means of the light guide 26. However, as compared to the preceding embodiment, the housing 4 is narrower in the area of the entrance 32 and thus it has a constriction. Consequently, the opening 8 is widened on the inside and has a funnel shape. In other words, the cross section of the free area provided by means of the opening 8 corresponds to the cross section of the free area of the preceding embodiment, but in that embodiment the cross section was determined by means of the appendage 30.

Between the further openings 38, which are also again widened on the inside, there is produced an outwardly open blind hole 40 in the base body 28, so that the light guide 26 has the blind hole 40 situated inside the opening 8. The blind hole 40 is configured as an indentation. The blind hole 40 is located in the middle of the portion of the base body 28 situated inside the opening 8. By means of the blind hole 40, foreign particles getting into the opening 8 through the entrance 32 and impinging on the light guide 26 are detained, e.g., by virtue of the surface forces and capillary forces, so that they cannot advance to the further openings 38 and clog them. In summary, the blind hole 40 is intended to catch the foreign particles here, instead of having them fall into the further openings 38.

FIG. 10 shows, schematically simplified, the path of the sound 42, i.e., the sound waves, entering into the opening 8 through the entrance 32. In the illustrated variant, the opening 8 is likewise widened inwardly. The sound 42 enters into the opening 8 through the entrance 32 and can only reach the microphone 6 via the further openings 38, so that the path of the sound 42 is partly curved. In comparison to this, when the light guide 26 is not present, the path of the sound 42 inside the opening 8 is a straight line and thus shorter, as shown in FIG. 11.

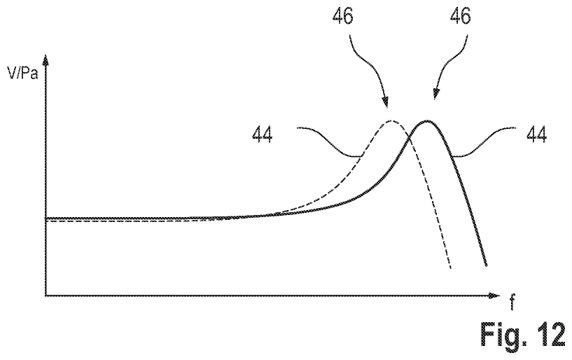

Due to the different length of the path of the sound 42, a different frequency response 44 is produced. This is shown in FIG. 12, being plotted in V/Pa (Volt per Pascal) against the respective frequency f. Because of the longer path of the sound 42 and the partly reduced cross-sectional area of the further opening 38, the acoustically effective mass is altered, so that the resonance frequency 46 is shifted toward lower frequencies. In summary, the frequency responses 44 differ in dependence on the presence of the light guide 26, even if the other components of the hearing device 2 are the same. The position, size, and shape of the further openings 38 are each chosen in dependence on the desired frequency response 44, so that in this way an adapting to the particular microphone 6 used and/or to the wearer of the hearing device 2 is accomplished. In other words, the further openings 38 are configured in dependence on the desired frequency response 44.

It will be understood that the invention is not limited to the exemplary embodiments described above. Instead, other variants of the invention can also be derived from them by the person skilled in the art, without leaving the scope of the invention. In particular, moreover, all individual features described in connection with the individual exemplary embodiments can also be combined with each other in another manner, without leaving the scope of the invention.

The following is a summary list of reference numerals and the corresponding structure used in the above description of the invention:
2 Hearing device
4 Housing
6 Microphone
8 Opening
10 Signal processing unit
12 Earpiece
14 Acoustic tube
16 Dome
18 Circuit board
20 Hole
22 Seal
24 Further lattice
26 Light guide
28 Base body
30 Appendage
32 Entrance
34 Lighting unit
36 LED
38 Further opening
40 Blind hole
42 Sound
44 Frequency response
46 Resonance frequency

1. A hearing device, comprising:
a housing formed with an opening;
a microphone disposed in said housing and acoustically connected to said opening;
a light guide disposed to close said opening;
a lighting unit disposed inside said housing and optically coupled to said light guide;
said light guide being formed with a further opening inside said opening of said housing.

2. The hearing device according to claim 1, wherein said further opening is configured in dependence on a desired frequency response of the hearing device.

3. The hearing device according to claim 1, wherein said further opening is one of a plurality of further openings formed in said light guide.

4. The hearing device according to claim 3, wherein said light guide has a lattice-shaped segment formed with said further openings.

5. The hearing device according to claim 1, wherein said light guide is glued to said housing, and wherein said light guide and said housing are provided with a common coating.

6. The hearing device according to claim 1, wherein said light guide is formed with a blind hole inside said opening in said housing, said blind hole being outwardly open towards an outside of said housing.

7. The hearing device wherein at least one of said opening in said housing or said further opening is inwardly widened at an inner end.

8. The hearing device according to claim 1, wherein said light guide comprises a hollow cylindrical appendage disposed to line said opening in said housing.
